(19) United States
(12) Patent Application Publication
(10) Pub. No.: US 2015/0117857 A1
(43) Pub. Date: Apr. 30, 2015

(54) SYSTEM AND METHOD FOR IN-BAND AMPLITUDE-MODULATED SUPERVISORY SIGNALING FOR POLARIZATION-MULTIPLEXED SYSTEMS

(71) Applicant: Fujitsu Limited, Kawasaki-shi (JP)

(72) Inventors: Olga Vassilieva, Plano, TX (US); Inwoong Kim, Allen, TX (US); Jeng-Yuan Yang, Garland, TX (US); Motoyoshi Sekiya, Richardson, TX (US)

(73) Assignee: Fujitsu Limited, Kawasaki-shi (JP)

(21) Appl. No.: 14/067,510

(22) Filed: Oct. 30, 2013

(51) Int. Cl. H04B 10/077; H04B 10/516; H04B 10/61; H04J 14/06

(52) U.S. Cl. CPC H04B 10/0775; H04J 14/06; H04B 10/5161; H04B 10/614
USPC 398/33

(57) ABSTRACT

Systems and method for monitoring a dual-polarization signal are disclosed. The systems and methods include adding a first supervisory signal to a first polarization component of the dual-polarization signal to get a first combined signal and adding a second supervisory signal to a second polarization component of the dual-polarization signal to get a second combined signal, either in the electrical or optical domain. The supervisory signal is arbitrary, non-complementary, and modulated at a amplitude substantially lower than the modulation frequency of the dual-polarization signal. The systems and methods further include analyzing the supervisory signal upon receipt.

### TECHNICAL FIELD

This invention relates generally to the field of optical networks and more specifically to monitoring a dual-polarization signal using an in-band supervisory signal.

### BACKGROUND

As the importance and ubiquity of optical communication systems increases, it becomes increasingly important to be able to accurately and efficiently monitor the optical communication system in order to ensure proper operation of the optical communication system. The importance of accurate and efficient monitoring increases as optical traffic signals are implemented comprising components with multiple polarizations (e.g., dual-polarization signals). It is increasingly important to be able to monitor the optical communication system in a cost-effective manner, as well as monitor in-line with other components of the optical communication system.

### SUMMARY OF THE DISCLOSURE

In accordance with certain embodiments of the present disclosure, systems and method for monitoring a dual-polarization signal are disclosed. The systems and methods include adding a first supervisory signal to a first polarization component of the dual-polarization signal to get a first combined signal and adding a second supervisory signal to a second polarization component of the dual-polarization signal to get a second combined signal, either in the electrical or optical domain. The supervisory signal is arbitrary, non-complementary, and modulated at a amplitude and frequency substantially lower than the modulation amplitude and frequency of the dual-polarization signal. The systems and methods further include analyzing the supervisory signal upon receipt.

### BRIEF DESCRIPTION OF THE DRAWINGS

For a more complete understanding of the present invention and its advantages, reference is now made to the following description, taken in conjunction with the accompanying drawings, in which:

FIG. 1 illustrates an example optical transmission system, in accordance with certain embodiments of the present disclosure;

FIG. 2 illustrates an example supervisory signal transmitter for transmitting arbitrary, non-complementary, amplitude-modulated supervisory signals in the electrical domain, in accordance with certain embodiments of the present disclosure; and

FIG. 3 illustrates an example supervisory signal transmitter for transmitting arbitrary, non-complementary, amplitude-modulated supervisory signals in the optical domain, in accordance with certain embodiments of the present disclosure;

FIG. 4 illustrates an alternative example supervisory signal transmitter for transmitting arbitrary, non-complementary, amplitude-modulated supervisory signals in the optical domain, in accordance with certain embodiments of the present disclosure;

FIG. 5 illustrates an example supervisory signal receiver for analyzing arbitrary, non-complementary, amplitude-modulated supervisory signals with different frequencies, in accordance with certain embodiments of the present disclosure;

FIG. 6 illustrates an example supervisory signal receiver for analyzing arbitrary, non-complementary, amplitude-modulated supervisory signals with the same frequency, in accordance with certain embodiments of the present disclosure; and

FIG. 7 illustrates a flowchart of an example method for analyzing a supervisory signal associated with an optical traffic signal, in accordance with certain embodiments of the present disclosure.

### DETAILED DESCRIPTION OF THE INVENTION

As used herein, the term “computer-readable media” may be any available media that may be accessed by a general purpose or special purpose computer. By way of example, and not limitation, such computer-readable media may comprise tangible computer-readable including RAM, ROM, EEPROM, CD-ROM or other optical disk storage, magnetic disk storage or other magnetic storage devices, or any other medium which may be used to carry or store desired program code means in the form of computer-executable instructions or data structures and which may be accessed by a general purpose or special purpose computer. Combinations of the above should also be included within the scope of computer-readable media.

Additionally, “computer-executable instructions” may include, for example, instructions and data which cause a general purpose computer, special purpose computer, or special purpose processing device to perform a certain function or group of functions.

As used herein, the term “module” or “component” may refer to software objects or routines that execute on a computing system. The different components, modules, engines, and services described herein may be implemented as objects or processes that execute on the computing system (e.g., as separate threads), as well as being implemented as hardware, firmware, and/or some combination of all three.

The following describes a cost-effective, in-line solution for monitoring an optical traffic signal of an optical communication system. The present disclosure describes systems and methods for monitoring a relatively low-modulation depth supervisory signal within existing components of the optical communication system in order to monitor wavelength and lightpath information associated with the optical communication system.

Telecommunications systems, cable television systems and data communication networks use optical networks to rapidly convey large amounts of information between remote points. In an optical network, information is conveyed in the form of optical signals through optical fibers or other optical media. The optical networks may include various components such as amplifiers, dispersion compensators, multiplexer/demultiplexer filters, wavelength selective switches, couplers, etc. configured to perform various operations within the optical network. The optical network may communicate supervisory data indicating any number of characteristics associated with the optical network, including source information, destination information and routing information, and other management information of the optical network.

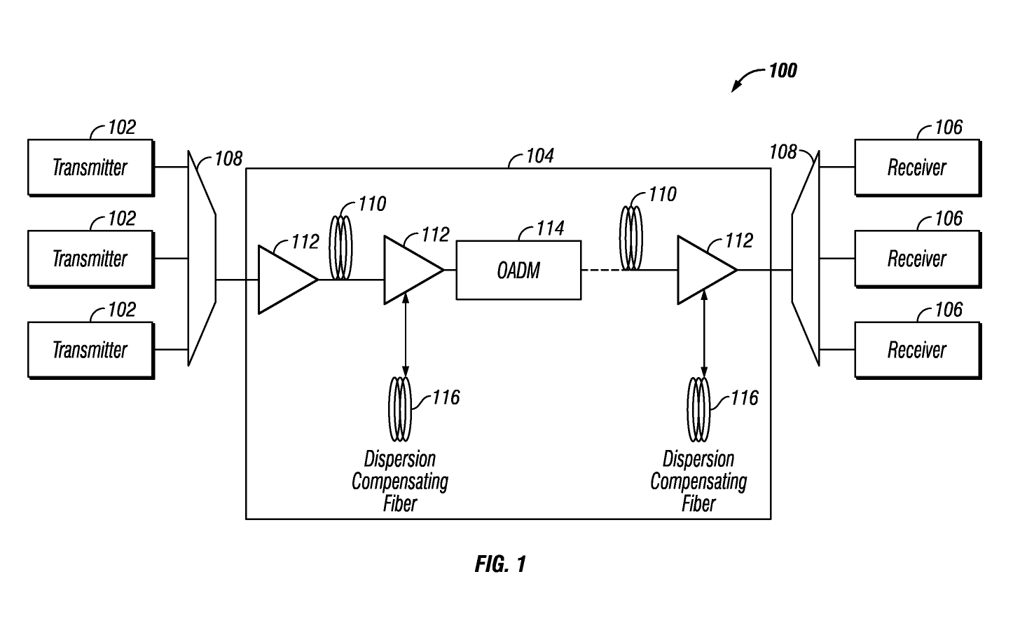

FIG. 1 illustrates an example optical network 100, in accordance with certain embodiments of the present disclosure. Network 100 may include transmitter 102, transmission system 104, and receiver 106. Network 100 may include one or more optical fibers 110 configured to transport one or more optical signals communicated by components of optical network 100. The network elements of optical network 100, coupled together by fibers 106, may include one or more transmitters 102, one or more multiplexers (MUX) 108, one or more amplifiers 112, one or more optical add/drop multiplexers (OADM) 114, and/or one or more dispersion compensating fibers 116.

The example system of FIG. 1 illustrates a simplified point-to-point optical system. Although one particular form or topography of network 100 is illustrated, network 100 may take any appropriate form, including a ring network, mesh network, and/or any other suitable optical network and/or combination of optical networks.

In some embodiments, transmitter 102 may be any electronic device, component, and/or combination of devices and/or components configured to transmit a multi-polarization optical signal to receiver 106. For example, transmitter 102 may include one or more lasers, processors, memories, digital-to-analog converters, analog-to-digital converters, digital signal processors, beam splitters, beam combiners, multiplexers, and/or any other components, devices, and/or systems required to transmit a dual-polarization optical signal to receiver 106.

In some embodiments, transmitter 102 may be further configured to include a supervisory signal in-band with the optical traffic signal. The systems and methods describing one particular implementation of the supervisory signal with a dual-polarization optical signal are described in more detail in U.S. patent application Ser. No. 13/620,102, and Ser. No. 13/620,172, both of which are hereby incorporated by reference. For the purposes of this disclosure, references to an “optical signal” and/or an “optical traffic signal” should be assumed to include the in-band supervisory signal unless expressly stated otherwise.

In some configurations of network 100, it may be costly to implement an in-band supervisory signal with a dual-polarization optical signal. For example, it may be necessary to install high-speed (and thus expensive) photo-detectors, processors, and/or polarimeters. However, in other configurations of network 100, one or more low-data rate supervisory signal(s) may be implemented, allowing for the use of low-speed (and thus lower-cost) photo-detectors, processors, and/or polarimeters. In some embodiments, a low-data rate supervisory signal may have a modulation period much longer than the data period of the optical traffic signal. In the same or alternative embodiments, the low-data rate supervisory signal(s) may allow the supervisory signal(s) to be more easily separated from a main data signal.

In some embodiments, transmitter 102 may communicate an optical traffic signal (along with one or more in-band supervisory signals) to receiver 106 via transmission system 104. Transmission system 104 may generally include the following components: one or more fiber 110, one or more OADM 114 module(s), and/or one or more amplifier(s) 112. With reference to FIG. 1, these components are provided to aid in illustration and are not intended to limit the scope of the present disclosure. In some configurations of network 100, network 100 may include more, fewer, and/or different components than those illustrated in FIG. 1.

In addition, the components of transmission system 104 may be communicatively coupled to one another through the use of fiber 110. In some embodiments, fiber 110 may be any appropriate optical fiber configured to carry data, such as a single-mode optical fiber or a non-zero dispersion shifted fiber. Transmission system 104 may also include amplifier 112. In some embodiments, amplifier 112 may be any amplifier configured to amplify the optical traffic signal (along with the one or more in-band supervisory signal) for more efficient transmission to receiver 106. For example, amplifier 112 may be an erbium doped fiber amplifier (“EDFA”) common to optical communication systems. In some embodiments, amplifier 112 may be responsible for certain types of noise introduced to the optical traffic signal. For example, an EDFA introduces a type of noise known to one of ordinary skill in the art as amplified spontaneous emission (“ASE”).

In some embodiments, amplifier 112 may be communicatively coupled to dispersion compensating fiber 116. Dispersion compensating fiber 116 may be any appropriate fiber and/or collection of fibers configured to compensate for any nonlinear effects associated with transmission system 104 such as chromatic dispersion.

In some embodiments, network 100 may also include one or more OADM 114. OADM 114 may be any appropriate component and/or collection of components configured to multiplex and/or route multiple wavelengths of light between and/or among nodes of network 100.

In some embodiments, receiver 106 may be any electronic device, component, and/or combination of devices and/or components configured to receive a multi-polarization optical signal from transmitter 102. For example, transmitter 102 may include one or more lasers, optical modulators, processors, memories, digital-to-analog converters, analog-to-digital converters, digital signal processors, beam splitters, beam combiners, demultiplexers, and/or any other components, devices, and/or systems required to receive a dual-polarization optical signal from transmitter 102.

In some embodiments, transmitter 102 and receiver 106 may be present in the same device, for example in an optical communication network including a plurality of optical nodes that are interconnected. In the same or alternative embodiments, transmitter 102 and receiver 106 may be separate devices, located either locally or remote from one another.

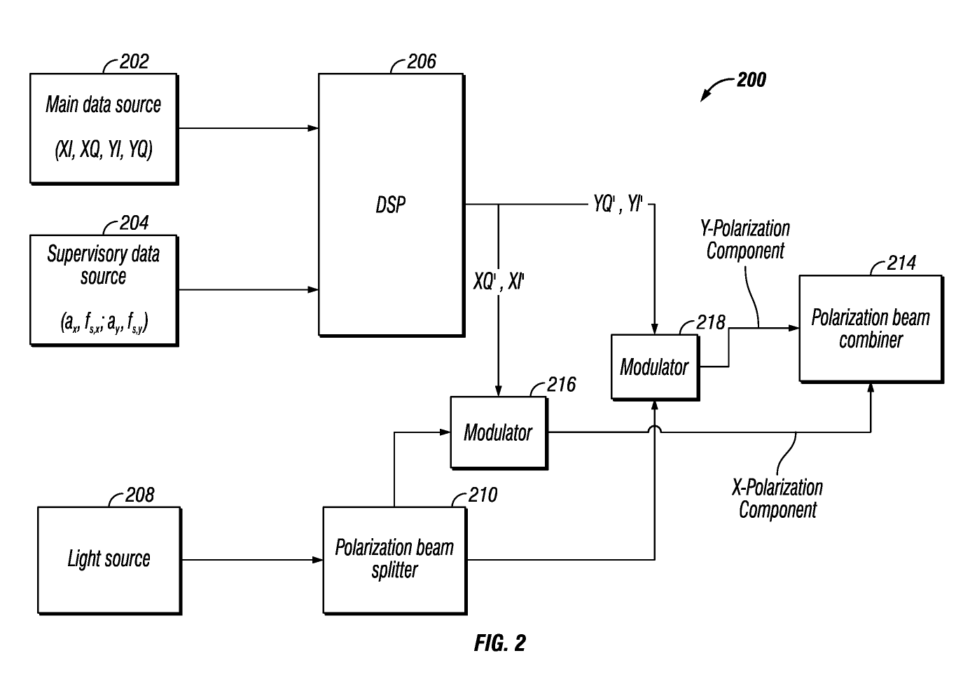

In operation, transmitter 102 may communicate a dual-polarization optical traffic signal (along with the one or more in-band supervisory signal(s)) to receiver 106 via transmission system 104. Each polarization tributary of the dual-polarization optical traffic signal may be multiplexed with an arbitrary, non-complementary, amplitude-modulated supervisory signal. In some embodiments, transmitter 102 may communicate the dual-polarization optical traffic signal via an appropriate modulation scheme. For example, transmitter 102 may communicate the dual-polarization optical traffic signal to receiver 104 via an amplitude or phase modulation technique. As an illustrative example, transmitter 102 may communicate the dual-polarization optical traffic signal using a quadrature phase-shift keying and/or quadrature amplitude modulation technique. In some embodiments, the modulation scheme used to transmit the data portion of the dual-polarization optical traffic signal may be different from the modulation scheme used to transmit the supervisory signal. For example, transmitter 102 may communicate the supervisory signal using non-complementary amplitude modulations, as described in more detail below with reference to FIGS. 2-6.

In some embodiments, transmitter 102 may be configured to create supervisory signal data for each polarization tributary of the dual-polarization signal. The modulation depth of the supervisory signal data may be relatively much smaller than the modulation depth of the main traffic signal data. For example, the supervisory signal data may be modulated at a depth that is 5% of the modulation depth of the main traffic signal data. Likewise, the frequency of the supervisory signal data may be relatively substantially less than that of the main traffic signal data. For example, the supervisory signal data may have a frequency in the MHz range while the main traffic data signal has a frequency in the GHz range.

The following configurations are presented as illustrative examples to aid in understanding and are not intended to limit the scope of the present disclosure. In some configurations of transmitter 102, the supervisory signal data for the x- and y-polarization tributaries may have the same modulation depth but different frequencies. For example, both x- and y-components of the supervisory signal may be modulated at 5% of the amplitude of the main traffic data signal, while the x-component has a frequency of 10 MHz and the y-component has a frequency of 17 MHz.

In the same or alternative configurations of transmitter 102, the supervisory signal data for the x- and y-polarization tributaries may have different modulation depths and different frequencies. For example, the x-component of the supervisory signal may be modulated at 3% of the amplitude of the main traffic data signal, while the y-component is modulated at 5%. Likewise, the x-component may have a frequency of 10 MHz, while the y-component has a frequency of 17 MHz.

In the same or alternative configurations of transmitter 102, the supervisory signal data for the x- and y-polarization tributaries may have different modulation depths and the same frequency. For example, the x-component of the supervisory signal may be modulated at 3% of the amplitude of the main traffic data signal, while the y-component is modulated at 5%. Both the x- and y-components may have a frequency of, e.g., 10 MHz.

In such configurations, the modulation depth of intensity in each polarization component is relatively small. Such a modulated supervisory signal data may be used for optical performance monitoring of each polarization component. Introducing an amplitude-modulated supervisory signal may result in a non-constant total signal power. In some configuration of network 100, this may cause an OSNR penalty due to certain nonlinear effects. However, certain configurations of network 100 may take advantage of a lack of dispersion compensating modules (“DCM”) at a node of network 100. DCM-less transmission may relax the impact of nonlinear effects.

By monitoring the supervisory signal communicated in-band with the optical traffic signal, network 100 may be able to determine the wavelength and lightpath properties associated with system 100.

FIG. 2 illustrates an example supervisory signal transmitter 200 for transmitting arbitrary, non-complementary, amplitude-modulated supervisory signals in the electrical domain, in accordance with certain embodiments of the present disclosure. In some embodiments, transmitter 200 may include main data source 202, supervisory data source 204, digital signal processor (“DSP”) 206, light source 208, polarization beam splitter 210, modulators 216, 218, and polarization beam combiner 214.

In some embodiments, supervisory data source 204 may be configured to provide an arbitrary, non-complementary, amplitude-modulated supervisory signal to DSP 206 as described in more detail above with reference to FIG. 1. For the purposes of the present disclosure, a non-complementary signal may be understood to be one in which the value of the x-component of the supervisory signal is not equal to the y-component of the supervisory signal, and in which the x-component of the supervisory signal does not have the opposite value of the y-component of the supervisory signal.

In some embodiments, DSP 206 and light source 208 may be part of a commercially-available transmitter 102. For example, DSP 206 may be a commercially-available digital signal processor integrated into, and/or configured to work alongside other components of transmitter 102. In this way, system 200 may be configured to provide a relatively lower-cost alternative to implementation in a network 100 in which digital signal processors are used with and/or in transmitter 102 by not requiring additional optical components.

In some embodiments, DSP 206 may be configured to combine the main data from main data source 202 with the data from supervisory data source 204 in the electrical domain such that no additional optical components may be required for in-band supervisory signal modulation. In some configurations, the modulation amplitude for the supervisory signal may be slow compared to the rate of the main data as described in more detail above with reference to FIG. 1.

In some embodiments, polarization beam splitter 204 may be configured to split the light from light source 202 into a plurality of polarization components. For example, polarization beam splitter 204 may be configured to split the light from light source 202 into x- and y-polarization components. For example, these polarization components may, for ease of reference only, be referred to as XI (e.g., the in-phase portion of the x-polarization component) and XQ (e.g., the quadrature portion of the x-polarization component) for the x-component of the light and YI (e.g., the in-phase portion of the y-polarization component) and YQ (e.g., the quadrature portion of the y-polarization component).

Polarization beam splitter 210 may be communicatively coupled to one or more modulators 216, 218. Modulators 216, 218 may be configured to modulate the incoming signal according to a provided driving signal. In some embodiments, the driving signal may be set according to the supervisory signal data. In some embodiments, DSP 206 may use data from main data source 202 and/or supervisory data source 204 in order to determine the appropriate driving signal as described in more detail below.

As an illustrative example, the driving signal for modulator 216 (e.g., the modulator associated with the x-component of the signal) may be denoted as XI′ and XQ′ and the driving signal for modulator 218 (e.g., the modulator associated with the y-component of the signal) may be denoted as YI′ and YQ′. The electric field of the driving signals with supervisory data modulation may be expressed as described below with reference to FORMULAS 1-4. With reference to FORMULAS 1-4 below, the x-polarization component of the supervisory signal may be denoted as having an amplitude of aₓ and a frequency of f_{s,x}, and the y-polarization component of the supervisory signal may be denoted as having an amplitude of a_{y} and a frequency of f_{s,y}.

XI′=sqrt[1+aₓ cos(2πf_{s,x}t+φ_{d})]·XI FORMULA 1

XQ′=sqrt[1+aₓ cos(2πf_{s,x}t+φ_{d})]·XQ FORMULA 2

YI′=sqrt[1+a_{y} cos(2πf_{s,y}t+φ_{d})]·YI FORMULA 3

YQ′=sqrt[1+a_{y} cos(2πf_{s,y}t+φ_{d})]·YQ FORMULA 4

In some embodiments, polarization beam combiner 214 may be an component configured to combine the signals from modulators 216, 218 into a multiplexed optical signal.

In the above configurations of transmitter 200, no additional optical components may be required for the modulation of the arbitrary, non-complementary, amplitude-modulated supervisory signals.

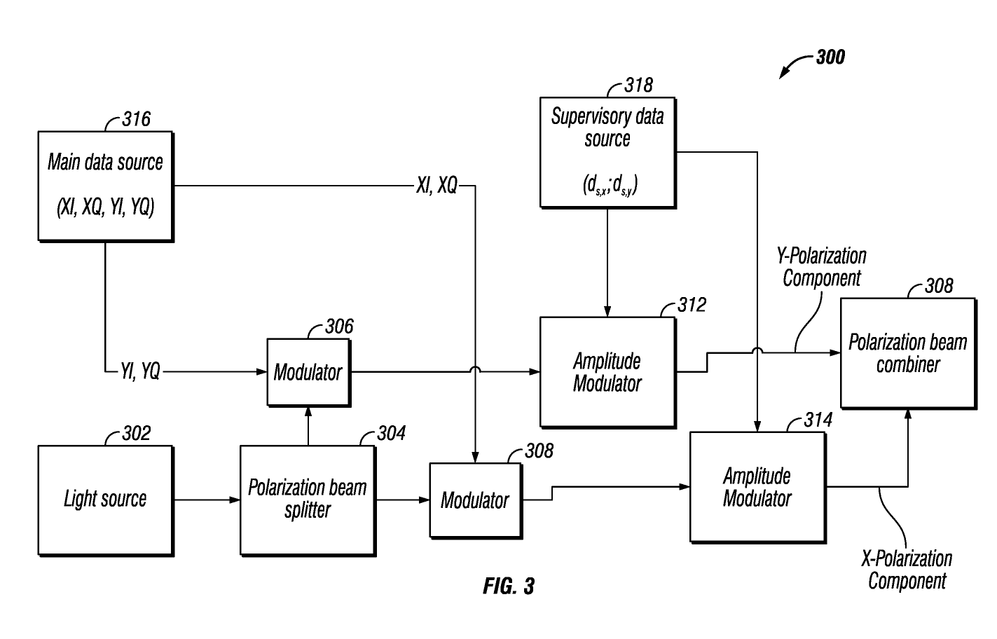

FIG. 3 illustrates an example supervisory signal transmitter 300 for transmitting arbitrary, non-complementary, amplitude-modulated supervisory signals in the optical domain, in accordance with certain embodiments of the present disclosure. In some embodiments, transmitter 300 may include main data source 316, supervisory data source 318, light source 302, polarization beam splitter 304, modulators 306, 308, polarization beam combiner 308, and one or more amplitude modulator(s) 312, 314.

In some embodiments, supervisory data source 318 may be configured to provide an arbitrary, non-complementary, amplitude-modulated supervisory signal to DSP 206 as described in more detail above with reference to FIG. 1. For the purposes of the present disclosure, a non-complementary signal may be understood to be one in which the value of the x-component of the supervisory signal is not equal to the y-component of the supervisory signal, and in which the x-component of the supervisory signal does not have the opposite value of the y-component of the supervisory signal.

In some embodiments, light source 302 may be any appropriate light source configured to provide a base light source for network 100. For example, light source 302 may be a laser and or combination of lasers configured to provide a light source to system 300. Light source 302 may transmit light to one or more polarization beam splitter(s) 304.

In some embodiments, polarization beam splitter 304 may be configured to split the light from light source 302 into a plurality of polarization components. For example, polarization beam splitter 304 may be configured to split the light from light source 302 into x- and y-polarization components. For example, these polarization components may, for ease of reference only, be referred to as XI (e.g., the in-phase portion of the x-polarization component) and XQ (e.g., the quadrature portion of the x-polarization component) for the x-component of the light and YI (e.g., the in-phase portion of the y-polarization component) and YQ (e.g., the quadrature portion of the y-polarization component).

Polarization beam splitter 304 may be communicatively coupled to one or more modulators 306, 308. Modulators 306, 308 may be configured to modulate the incoming signal according to a provided driving signal. For ease of reference, this driving signal may be referenced as XI, XQ, YI, and YQ, as described in more detail above with reference to FIG. 2. In contrast to the example transmitter 200 described above with reference to FIG. 2, transmitter 300 may be configured to multiplex the supervisory signal data with the main signal data through the use of additional optical components—amplitude modulators 312, 314 communicatively coupled to modulators 306, 308—rather than the digital signal processor employed in the example transmitter 200.

In some embodiments, amplitude modulators 312, 314 may be any components and/or set of components configured to modulate an incoming signal in an appropriate amplitude modulation scheme. Amplitude modulators 312, 314 may be configured to modulate the incoming signal in association with the supervisory signal data from supervisory data source 318. In some embodiments, the amplitude modulation depth may be substantially less than 1 because the supervisory signal may have high sensitivity due to a low data rate. For ease of reference, the supervisory signal data may be denoted as having an x-polarization component denoted as d_{s,x} and a y-polarization component denoted as d_{s,y}. Each modulated signal may then be combined at polarization beam combiner 310.

Amplitude modulators 312, 314 may be configured to provide optical domain modulation of in-band supervisory signal data.

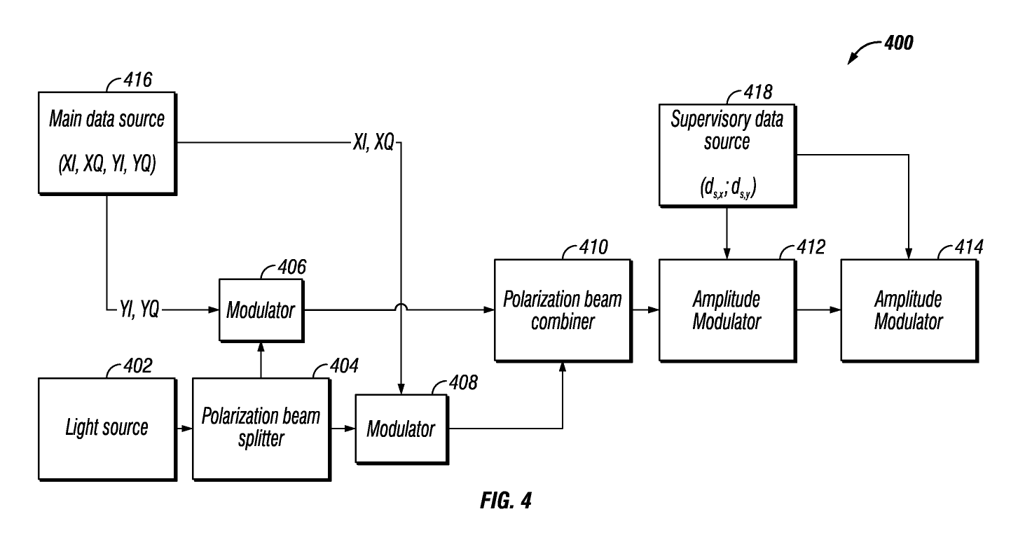

FIG. 4 illustrates an alternative example supervisory signal transmitter 400 for transmitting arbitrary, non-complementary, amplitude-modulated supervisory signals in the optical domain, in accordance with certain embodiments of the present disclosure. In some embodiments, transmitter 400 may include main data source 416, supervisory data source 418, light source 402, polarization beam splitter 404, modulators 406, 408, polarization beam combiner 410, and one or more amplitude modulator(s) 412, 414.

In contrast to the example transmitter 300 described above with reference to FIG. 3, transmitter 400 may be configured to have amplitude modulators 412, 414 configured to modulate the signal in accordance with the supervisory signal data after the two signals have been combined at polarization beam combiner 410. In such configurations, amplitude modulator 412 may, for example, be configured to provide the amplitude modulation of the x-component of the signal while amplitude modulator 414 may be configured to provide the amplitude modulation of the y-component of the signal.

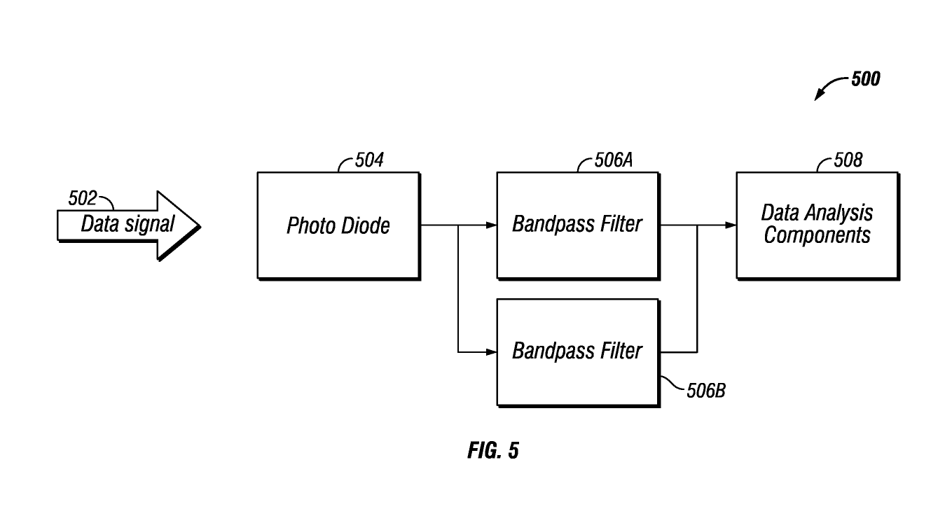

FIG. 5 illustrates an example supervisory signal receiver 500 for analyzing arbitrary, non-complementary, amplitude-modulated supervisory signals with different frequencies, in accordance with certain embodiments of the present disclosure. In some embodiments, receiver 500 may include data signal 502, a plurality of bandpass filter(s) 506A, 506B, one or more photo diode(s) 504, and one or more data analysis component(s) 508.

In some embodiments, data signal 502 may include an optical traffic signal along with a superimposed supervisory signal, as described in more detail above with reference to FIG. 1. Data signal 502 may be incident on one or more photo diode(s) 504. In some embodiments, photo diode 504 may be any component configured to convert an optical signal into an electric signal. For example, photo diode 504 may be a relatively low-speed photo diode due to the relatively low modulation speed of the supervisory signal. Once the supervisory signal data has been converted, it may be communicated to one or more bandpass filter(s) 506.

Bandpass filters 506A, 506B may be configured to extract the x- and y-components of the supervisory signal. For example, bandpass filter (“BPF”) 506 may be a tunable BPF configured to pass the x- and/or y-components of the supervisory signal. Because the polarization components of the supervisory signal data have different frequencies, the two supervisory signal data components will be separate from each other in the frequency domain and may be separated through the use of BPF 506. For example, bandpass filter 506A may be configured to filter the frequency associated with the x-component of the supervisory signal data (e.g., 10 MHz) while bandpass filter 506B may be configured to filter the frequency associated with the y-component of the supervisory signal data (e.g., 17 MHz). Once the supervisory signal data has been isolated, it may be communicated to one or more data analysis components 508.

In some embodiments, data analysis component(s) 508 may be any component configured to analyze the extracted supervisory signal. For example, data analysis component(s) 508 may include a power meter, digital signal processor, microprocessor, microcontroller, and/or any appropriate component configured to analyze the extracted supervisory signal data. For example, data analysis component 508 may be a power meter configured to analyze the extracted supervisory signal data for an optical power level. As another example, data analysis component 508 may be a microprocessor configured to gather lightpath information from the extracted supervisory signal data.

In some embodiments, the relatively low cost of the components included in receiver 500 may allow receiver 500 to be implemented in-line in network 100. In the same or alternative embodiments, the components of receiver 500 may be included in a stand-alone optical receiver, and/or any other appropriate configuration of optical receiver(s).

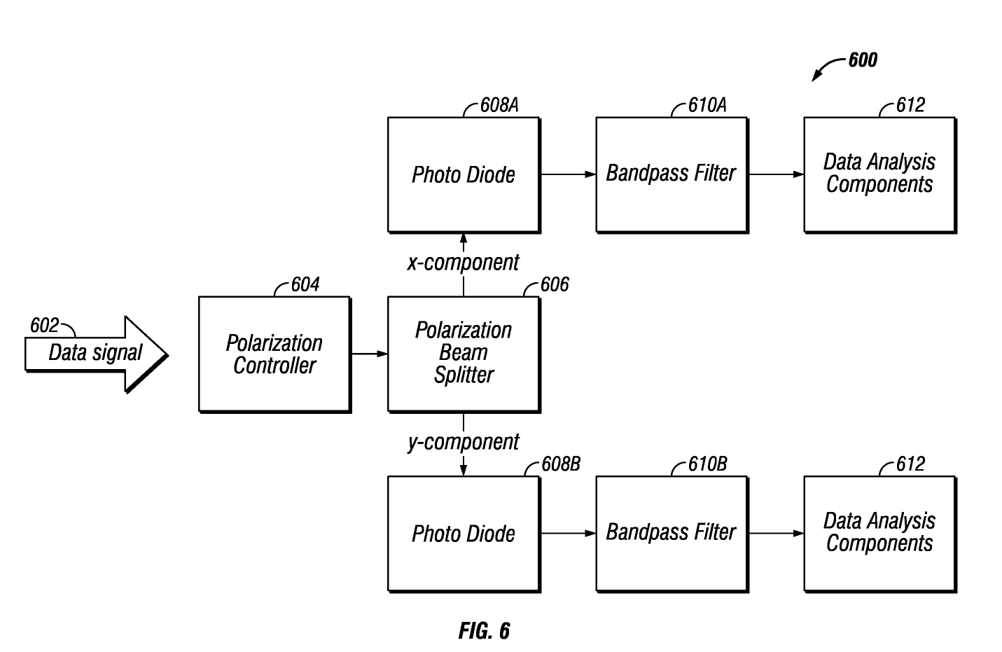

FIG. 6 illustrates an example supervisory signal receiver 600 for analyzing arbitrary, non-complementary, amplitude-modulated supervisory signals with the same frequency, in accordance with certain embodiments of the present disclosure. In some embodiments, receiver 600 may include data signal 602, polarization controller 604, polarization beam splitter 606, a plurality of bandpass filter(s) 610A, 610B, one or more photo diode(s) 608, and one or more data analysis component(s) 612.

In some embodiments, data signal 602 may include an optical traffic signal along with a superimposed supervisory signal, as described in more detail above with reference to FIG. 1. Data signal 602 may be incident on polarization controller 604. In some embodiments, polarization controller 604 may be any component configured to normalize the state of polarization (“SOP”) of data signal 602. For example, polarization controller 604 may be a polarization controller configured to set the state of polarization to 45 degrees. Polarization controller 604 may be communicatively coupled to polarization beam splitter 606, which may be configured to separate the polarization components of the SOP-normalized data signal.

In some embodiments, as described in more detail above with reference to FIG. 1, the polarization components of the supervisory signal data may have different amplitude modulation depths but the same frequency. In such configurations of network 100, polarization beam splitter 606 may be included in receiver 600 in order to separate the polarization components of the supervisory signal. Polarization beam splitter 606 may be communicatively coupled to a plurality of photo diodes 608A, 608B.

In some embodiments, photo diodes 608A, 608B may be any component configured to convert an optical signal into an electric signal. For example, photo diodes 608A, 608B may be a relatively low-speed photo diode due to the relatively low modulation speed of the supervisory signal. Photo diodes 608A, 608B may be communicatively coupled to one or more bandpass filter(s) 610.

Bandpass filters 610A, 610B may be configured to extract the x- and y-components of the supervisory signal. For example, bandpass filter (“BPF”) 610 may be a tunable BPF configured to pass the x- and/or y-components of the supervisory signal. For example, bandpass filters 610A, 610B may be configured to filter the frequency associated with the polarization components of the supervisory signal data (e.g., 10 MHz). Bandpass filters 610A, 610B may be communicatively coupled to one or more data analysis components 612.

In some embodiments, data analysis component(s) 612 may be any component configured to analyze the extracted supervisory signal. For example, data analysis component(s) 612 may include a power meter, digital signal processor, microprocessor, microcontroller, and/or any appropriate component configured to analyze the extracted supervisory signal data. For example, data analysis component 612 may be a power meter configured to analyze the extracted supervisory signal data for an optical power level. As another example, data analysis component 612 may be a microprocessor configured to gather lightpath information from the extracted supervisory signal data.

In some embodiments, analysis of the different polarization components of the supervisory signal data may be handled by the same and/or different data analysis components 612 depending on the desired configuration of receiver 600.

In some embodiments, the relatively low cost of the components included in receiver 600 may allow receiver 600 to be implemented in-line in network 100. In the same or alternative embodiments, the components of receiver 600 may be included in a stand-alone optical receiver, and/or any other appropriate configuration of optical receiver(s).

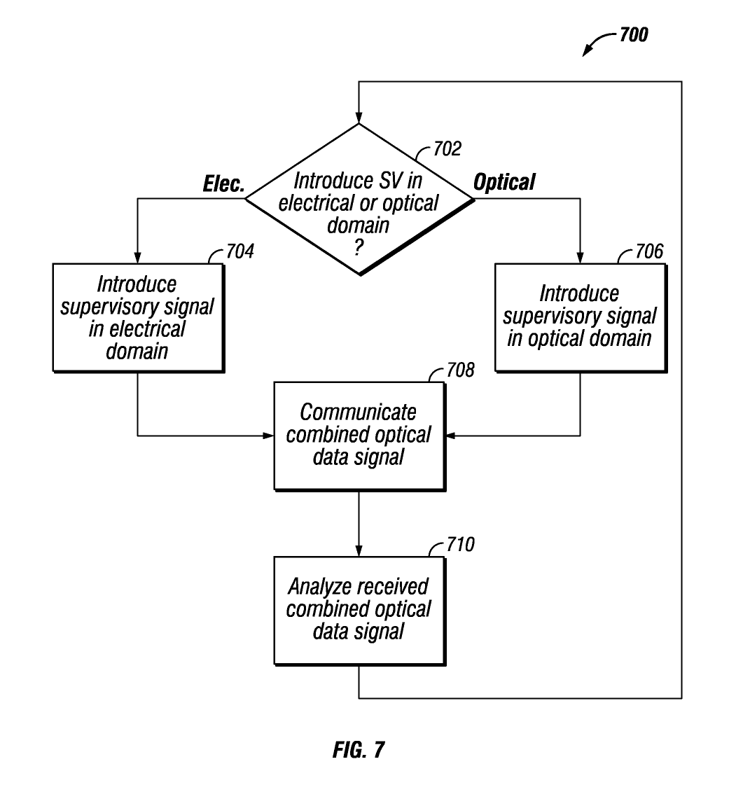

FIG. 7 illustrates a flowchart of an example method 700 for analyzing a supervisory signal associated with an optical traffic signal, in accordance with certain embodiments of the present disclosure. Method 700 may include introducing an arbitrary, non-complementary, amplitude-modulated supervisory signal, filtering, the supervisory signal data from the main data signal, and analyzing the supervisory signal data.

According to one embodiment, method 700 may begin at 702. Teachings of the present disclosure may be implemented in a variety of configurations. As such, the preferred initialization point for method 700 and the order of 702-710 comprising method 700 may depend on the implementation chosen.

At 702, method 700 may determine whether to introduce the supervisory signal data in the electrical domain or the optical domain, as described in more detail above with reference to FIGS. 1-4. If the supervisory signal is to be introduced via the electrical domain, method 700 may proceed to step 704. If the supervisory signal is to be introduced via the optical domain, method 700 may proceed to step 706.

At step 704, method 700 may introduce a supervisory signal to an optical data signal in the electrical domain, as described in more detail above with reference to FIGS. 1-2. For example, method 700 may introduce a supervisory signal with both an x- and a y-component to a dual-polarization data signal. In some embodiments, this may include using a digital signal processor to combine the supervisory signal data from a supervisory data source with main signal data from a main data source. After introducing the supervisory signal data, method 700 may proceed to step 708.

Referring again to step 706, method 700 may introduce a supervisory signal to an optical data signal in the optical domain, as described in more detail above with reference to FIGS. 1 and 3-4. For example, method 700 may introduce a supervisory signal with both an x- and a y-component to a dual-polarization data signal. In some embodiments, this may include using a plurality of amplitude modulators to modulate the main signal data with the supervisory signal data. After introducing the supervisory signal data, method 700 may proceed to step 708.

At step 708, method 700 may communicate the combined optical data signal through the remainder of network 100. For example, transmitter 102 may communicate the combined optical data signal (e.g., the combination of the main data and the supervisory signal) to another component of traffic system 102. After communicating the combined optical data signal, method 700 may proceed to step 710.

At step 710, method 700 may analyze the received combined optical data signal in order to determine information included in the supervisory signal data, as described in more detail above with reference to FIGS. 1-6. For example, method 700 may use a plurality of filters, photo diodes, and/or data analysis components to separate the individual polarization components of the supervisory signal from the combined optical data signal. As described in more detail above with reference to FIGS. 5-6, this may be done in line with network 100 and/or by certain components of receiver 102. In some embodiments, the analysis may include determining certain information associated with the supervisory signal, e.g., the optical power, lightpath information, etc. After analyzing the combined optical data signal, method 700 may return to step 702 to begin the process again.

Although FIG. 7 discloses a particular number of steps to be taken with respect to method 700, method 700 may be executed with more or fewer than those depicted in FIG. 7. For example, in some configurations of network 100, the analysis of the supervisory signal data may occur simultaneously with further communication of the combined optical data signal (e.g., when performing in-line analysis). Further, in some configurations of network 100, both electrical domain and/or optical domain combinations of the main data signal data and supervisory signal data may be performed.

What is claimed:

1. A method for monitoring a dual-polarization signal, the method comprising:
in the electrical domain, adding a first supervisory signal to a first polarization component of the dual-polarization signal to get a first combined signal; and
in the electrical domain, adding a second supervisory signal to a second polarization component of the dual-polarization signal to get a second combined signal, wherein the first and second supervisory signals are:
non-complementary; and
modulated at an amplitude substantially lower than the amplitude of the dual-polarization signal.

2. The method of claim 1, wherein the first and second supervisory signals have different modulation amplitudes.

3. The method of claim 1, wherein the first and second supervisory signals have different frequencies.

4. The method of claim 1, further comprising combining the first combined signal and the second combined signal into a combined data signal.

5. The method of claim 4, further comprising filtering the first supervisory signal from the combined data signal.

6. The method of claim 5, further comprising analyzing the first supervisory signal to determine wavelength information associated with the first polarization component of the dual-polarization signal.

7. The method of claim 5, further comprising analyzing the first supervisory signal to determine lightpath information associated with the first polarization component of the dual-polarization signal.

8. The method of claim 4, further comprising filtering the second supervisory signal from the combined data signal.

9. The method of claim 8, further comprising analyzing the second supervisory signal to determine wavelength information associated with the second polarization component of the dual-polarization signal.

10. The method of claim 9, further comprising analyzing the second supervisory signal to determine lightpath information associated with the second polarization component of the dual-polarization signal.

11. A method for monitoring a dual-polarization signal, the method comprising:
in the optical domain, adding a first supervisory signal to a first polarization component of the dual-polarization signal to get a first combined signal; and
in the optical domain, adding a second supervisory signal to a second polarization component of the dual-polarization signal to get a second combined signal, wherein the first and second supervisory signals are:
non-complementary; and
modulated at an amplitude substantially lower than the amplitude of the dual-polarization signal.

12. The method of claim 11, wherein the first and second supervisory signals have different modulation amplitudes.

13. The method of claim 11, wherein the first and second supervisory signals have different frequencies.

14. The method of claim 11, further comprising combining the first combined signal and the second combined signal into a combined data signal.

15. The method of claim 14, further comprising filtering the first supervisory signal from the combined data signal.

16. The method of claim 15, further comprising analyzing the first supervisory signal to determine wavelength information associated with the first polarization component of the dual-polarization signal.

17. The method of claim 15, further comprising analyzing the first the supervisory signal to determine lightpath information associated with the first polarization component of the dual-polarization signal.

18. The method of claim 14, further comprising filtering the second supervisory signal from the combined data signal.

19. The method of claim 18, further comprising analyzing the second supervisory signal to determine wavelength information associated with the second polarization component of the dual-polarization signal.

20. The method of claim 19, further comprising analyzing the second supervisory signal to determine lightpath information associated with the second polarization component of the dual-polarization signal.

21. An optical transmitter comprising:
a main data source configured to generate a main data signal including a first polarization component and a second polarization component;
a supervisory data source configured to generate a first supervisory signal and a second supervisory signal, wherein the first and second supervisory signals are non-complementary, frequency-modulated supervisory signals;
a digital signal processor configured to:
add the first supervisory signal to the first polarization component of the main signal to get a first combined signal; and
add the second supervisory signal to the second polarization component of the main data signal to get a second combined signal.

22. An optical transmitter comprising:
a main data source configured to generate a main data signal including a first polarization component and a second polarization component;
a supervisory data source configured to generate a first supervisory signal and a second supervisory signal, wherein the first and second supervisory signals are non-complementary, frequency-modulated supervisory signals;
a first amplitude modulator configured to modulate the first supervisory signal with the first polarization component of the main signal to get a first combined signal;
a second amplitude modulator configured to modulate the second supervisory signal with the second polarization component of the main data signal to get a second combined signal; and
a polarization beam combiner configured to combine the first combined signal and the second combined signal.

23. An optical receiver for analyzing a combined optical signal, the optical receiver comprising:
a first filter configured to filter a plurality of supervisory signals from the combined optical signal;
a data analysis component configured to extract information from the plurality of supervisory signals, wherein the supervisory signals are an arbitrary, non-complementary, amplitude-modulated supervisory signal.

24. The receiver of claim 23, wherein the plurality of supervisory signals have different frequencies.

25. The receiver of claim 23, wherein the plurality of supervisory signals have different modulation amplitudes.

26. The receiver of claim 23, wherein the data analysis component comprises:
a plurality of filters configured to separate the plurality of supervisory signals into a plurality of components prior to analysis; and
an analyzer configured to extract information from the plurality of components.

27. The receiver of claim 21, wherein the data analysis component is configured to extract wavelength information from individual components of the supervisory signals.

28. The receiver of claim 21, wherein the data analysis component is configured to extract lightpath information from individual components of the supervisory signals.

29. The receiver of claim 23, wherein the plurality of components of the supervisory signals have the same frequency.

30. The receiver of claim 30, wherein the receiver further comprises a polarization beam splitter configured to separate the plurality of components of the supervisory signal.
